(19) United States
(12) Patent Application Publication
(10) Pub. No.: US 2007/0111066 A1
(43) Pub. Date: May 17, 2007

(54) Aeroplane Steam-Bath Facility

(75) Inventors: Claus Hoffjann, Hamburg (DE); Andreas Westenberger, Buxtehude (DE)

Correspondence Address: WOOD, HERRON & EVANS, LLP, 2700 CAREW TOWER, 441 VINE STREET, CINCINNATI, OH, 45202, US

(73) Assignee: AIRBUS DEUTSCHLAND GMBH, Hamburg (DE)

(21) Appl. No.: 11/560,537

(22) Filed: Nov. 16, 2006

(30) Foreign Application Priority Data
Nov. 17, 2005 (DE) 10 2005 054 882.2

(51) Int. Cl. H01M 8/04; H01M 8/10

(52) U.S. Cl. 429/26; 429/30

(57) ABSTRACT

A wellness facility (10), which is suitable, in particular, for use on board an aeroplane, comprises a wellness unit (12) and a supply unit (14). The supply unit (14) comprises a fuel-cell system (16) with a fuel cell (18) and is adapted to supply the wellness unit (12) with water generated by the fuel cell (18).

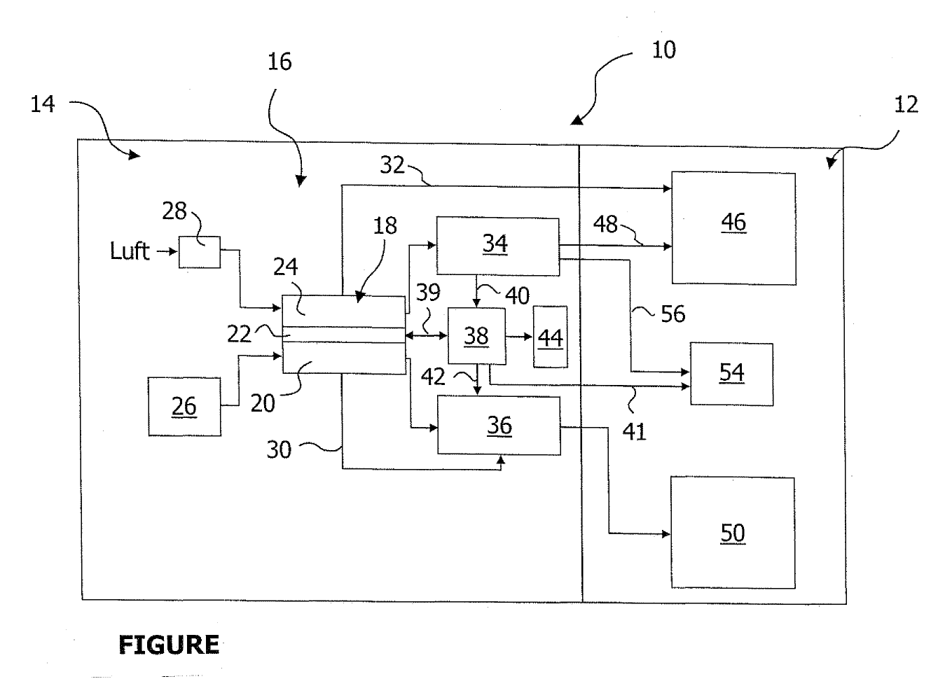

The invention relates to an aeroplane steam-bath facility.

Particularly in the case of private jets that are built to order individually there is frequently a desire on the part of the customer for an exclusive layout. In addition to amenities such as, for example, an office equipped with appropriate technical aids, a living-area or a bedroom, wellness amenities especially—such as, for example, a fitness area, a sauna or a steam bath, which serve to make the flight more pleasant and more diverting for the passengers—constitute layout features that are in demand. However, a relatively large amount of energy is required for the operation of a sauna or steam bath on board an aeroplane. Over and above this, a relatively large quantity of water has to be provided for sauna infusions, for the generation of steam, and also for showers in the area of the sauna and steam bath, for example, and said water has to be stored in freeze-proof manner in a tank in the heated area of the aeroplane.

DE 10 2004 034 870 A1, which is published after the priority date of the present application, describes a system for recovering water from a stream of waste gas of a fuel cell of an aircraft. The system includes a fuel cell and also a condenser connected downstream of the fuel cell, in which the condensation of water contained in the waste gas of the fuel cell takes place. The water that has been separated from the waste gas of the fuel cell is utilised for the purpose of supplying the fuel cell with water, and can optionally be employed, in addition, for the purpose of improving the cooling capacity of a principal heat-transfer medium or of a ram-air cooler of an aeroplane air-conditioning system.

DE 102 49 588 A1 discloses a fuel-cell system for generating water on board an aeroplane, wherein a condensation process which condenses water out of some of the anode waste gas of the fuel cell is connected downstream of a high-temperature fuel cell. The water is supplied to galleys, wash-basins, showers and toilets provided on board the aeroplane.

From DE 102 16 709 A1 a process is known for processing water recovered from fuel cells on board an aeroplane. The water is provided for use in toilet flushes, as drinking-water, shower water, washing-water and for the purpose of air humidification.

The object underlying the invention is to make available an aeroplane steam-bath facility that can be operated in energy-efficient manner and that is suitable, in particular, for use on board an aeroplane.

With a view to achieving the aforementioned object, an aeroplane steam-bath facility according to the invention comprises a steam-bath unit with a steam bath and also a supply unit. The supply unit includes a fuel-cell system with a fuel cell and a steam-preparation unit connected to the steam bath for the purpose of processing water and/or water vapour generated by the fuel cell.

The fuel cell that is employed in the supply unit of the aeroplane steam-bath facility according to the invention includes a cathode region and an anode region, said anode region being separated from the cathode region by an electrolyte. During operation of the fuel cell, hydrogen is supplied to the anode side of the fuel cell, and an oxygenous oxidising agent—air, for example—is supplied to the cathode side of the fuel cell. The hydrogen molecules react on an anode catalyst which is present in the anode region, in accordance with the equation
H₂→2·H⁺+2·e⁻
and in the process emit electrons to the electrode while creating positively charged hydrogen ions.

The H⁺-ions that are created in the anode region subsequently diffuse through the electrolyte to the cathode, where they react—on a cathode catalyst which is present in the cathode region and which is typically applied onto a carbon support—with the oxygen supplied to the cathode and also with the electrons that have been conducted to the cathode via an external electric circuit, to form water in accordance with the equation
0.5·O₂+2·H⁺+2·e⁻→H₂O.

The operating temperature of the fuel cell depends on the type of the electrolyte employed in the fuel cell. For instance, the operating temperature of a conventional polymer-electrolyte-membrane fuel cell is about 60-80° C.

A particular advantage of the aeroplane steam-bath facility according to the invention consists in the fact that the water arising as reaction product during operation of the fuel cell can be optimally utilised in the steam-bath unit. In the case where the aeroplane steam-bath facility according to the invention is employed on board an aeroplane, a water tank for the purpose of storing water for the operation of the aeroplane steam-bath facility can consequently be dispensed with. The aeroplane steam-bath facility according to the invention is therefore capable of being operated in particularly energy-efficient manner in terms of the overall balance.

In principle it is possible to generate water or water vapour of drinking-water quality in a fuel cell. Prerequisites for this are a sufficient purity of the educts supplied to the fuel cell and also a design of the relevant components of the fuel-cell system, which come into contact with the educts supplied to the fuel cell and with the water or water vapour generated by the fuel cell, that is as sterile as possible and as suitable as possible for food-contact applications. In the aeroplane steam-bath facility according to the invention the relevant components of the supply unit are therefore preferably kept as clean as possible, as sterile as possible and as suitable as possible for food-contact applications. It is ensured by this means that the steam-bath unit of the aeroplane steam-bath facility is supplied at all times with water or water vapour of constantly high quality, preferably of drinking-water quality.

The steam-preparation unit ensures that the water/water-vapour mixture issuing from the fuel cell of the supply unit, which—depending on the operating temperature of the fuel cell—may have varying compositions, varying temperatures and varying pressures, is brought to the temperatures and pressures required for use for the purpose of operating the steam bath of the steam-bath unit. In the aeroplane steam-bath facility according to the invention the water vapour generated by the steam-preparation unit is used for the operation of the steam bath. If desired, appropriate scented substances or substances for inhalation may be added to the water vapour in the steam-preparation unit or in a device connected downstream of the steam-preparation unit.

The steam-preparation unit is furthermore electrically connected to the fuel-cell system, in order to be supplied with energy generated by the fuel cell of the supply unit, i.e. with electrical energy generated by the fuel cell. Furthermore, the steam-preparation unit may be capable of being controlled by means of an electronic control unit, for instance, in order to be able to adapt the steam-processing process, where appropriate, to varying requirements during operation of the aeroplane steam-bath facility. The steam-preparation unit preferably further includes a collecting area that has an appropriately large volume in order to be able to store a certain quantity of water vapour temporarily when required.

The steam-preparation unit is preferably capable of being connected to a water-vapour storage container pertaining to the steam-bath unit, so that the water-vapour storage container can be filled, when required, with the water vapour generated by the steam-preparation unit or with the water vapour stored temporarily in the collecting area of the steam-preparation unit. If the steam-bath unit does not have a steam storage container, the steam-preparation unit may also be directly connected to the steam bath and/or to another amenity pertaining to the steam-bath unit.

The supply unit is furthermore preferably adapted to supply the steam-bath unit with energy generated by the fuel cell. In other words, in the aeroplane steam-bath facility according to the invention the energy generated by the fuel cell, i.e. the electrical energy generated during operation of the fuel cell and/or the thermal energy arising during operation of the fuel cell, can be supplied to the steam-bath unit and can be utilised there for various purposes. For instance, electrical energy generated by the fuel cell may serve for driving electrical loads in the steam-bath unit, such as, for example, an electrical heating system, a pump or a lighting system. Thermal energy generated by the fuel cell may, on the other hand, be utilised directly for heating individual amenities pertaining to the steam-bath unit or for heating the entire steam-bath unit.

The supply unit may be provided exclusively for the purpose of supplying water or water vapour and, when required, also energy to the steam-bath unit of the aeroplane steam-bath facility according to the invention. Alternatively, however, the supply unit may also be a part of a separate or higher-ranking energy-supply system and/or water-supply system and, in addition to supplying the steam-bath unit of the aeroplane steam-bath facility according to the invention, may also supply other systems on board the aeroplane with water or water vapour generated by the fuel cell and/or with energy generated by the fuel cell.

The steam-bath unit of the aeroplane steam-bath facility according to the invention preferably includes a sauna and/or at least one shower. Amenities of such a type enable a particularly efficient utilisation of the water or water vapour generated by the fuel cell of the supply unit, and also of the energy generated by the fuel cell. The shower may be a pure cold-water shower for use after a sauna, or a cold-water/hot-water shower. Of course, several showers may also be present. Furthermore, the aeroplane steam-bath facility according to the invention may be equipped with a changing-area, with a fitness area and/or with a solarium.

The steam-bath unit of the aeroplane steam-bath facility according to the invention may include one or more storage containers for receiving the water and/or water vapour generated by the fuel cell of the supply unit. The storage container(s) may, for instance, be connected to the individual amenities of the steam-bath unit, i.e. the sauna, the steam bath, the shower or such like, in order to supply the amenities with the requisite water and/or water vapour. Depending on demand, the storage container(s) may be heated or cooled, for which purpose the electrical energy generated by the fuel cell of the supply unit may be utilised or, in the case of heating, the thermal energy generated by the fuel cell may also be utilised directly. Alternatively, or in addition, the storage container(s) may also be provided with an appropriate insulation which, where appropriate, is also capable, without additional heating or cooling, of maintaining water and/or water vapour that has been conducted away from the fuel cell of the supply unit at the temperature required for the operation of the respective amenities.

In the steam-bath unit of the aeroplane steam-bath facility according to the invention an energy storage device for storing the electrical energy generated by the fuel cell of the supply unit may furthermore be provided. The energy storage device—which, for instance, is designed in the form of a rechargeable battery—is preferably electrically connected to the fuel cell of the supply unit, so that it can also be recharged when required by the electrical energy generated by the fuel cell. By virtue of the provision of an energy storage device in the steam-bath unit, electrical loads pertaining to the steam-bath unit—such as, for example, an electrical heating system, a pump or a lighting system—can be operated, at least for a certain time, independently of the supply unit.

The fuel cell that is employed in the supply unit of the aeroplane steam-bath facility according to the invention is preferably a polymer-electrolyte-membrane fuel cell, in which case in a particularly preferred embodiment of the wellness facility according to the invention a high-temperature polymer-electrolyte-membrane fuel cell comes into operation. In principle, polymer-electrolyte-membrane fuel cells have the advantage that they are relatively easy to produce, since the membrane films employed as electrolyte are relatively insensitive and can be handled straightforwardly. Furthermore, during operation of the fuel cell the electrolyte is not consumed and therefore does not have to be replaced or reconditioned during the operating life of the cell. Moreover, polymer-electrolyte-membrane fuel cells have a relatively long service life. Finally, polymer-electrolyte-membrane fuel cells can be started up and shut down relatively easily and quickly.

High-temperature polymer-electrolyte-membrane fuel cells differ from conventional polymer-electrolyte-membrane fuel cells by virtue of the type of the electrolyte membrane employed in the fuel cell, which, depending on composition, in contrast to conventional polymer-electrolyte-membrane fuel cells enables elevated operating temperatures of about 120° C.-300° C. In the aeroplane steam-bath facility according to the invention the use of a high-temperature polymer-electrolyte-membrane fuel cell has the advantage that at the elevated operating temperature of this cell a sterilisation of the water arising in the course of the fuel-cell reaction already takes place in the cell.

In a preferred embodiment of the wellness facility according to the invention the fuel-cell system of the supply unit includes a hydrogen tank connected to an anode region of the fuel cell. Ideally, the hydrogen tank is suitable for receiving liquid hydrogen and may, for instance, include an inner vessel, with a wall made of steel or aluminium, which is surrounded by one or more heat-insulating layers. The inner vessel of the liquid-hydrogen tank may be arranged in an outer vessel made of steel or aluminium, it being possible for the space between the inner vessel and the outer vessel to be filled with materials that conduct heat poorly.

The storage temperature of liquid hydrogen amounts to approximately −253° C., which—particularly in the case where liquid hydrogen is used as fuel for a fuel-cell system on board an aeroplane—has the advantage that the hydrogen tank can be accommodated in the unheated loading area of the aeroplane outside the cabin, without there being the problem of the fuel freezing. Furthermore, liquid hydrogen is available with a very high degree of purity, which has a positive effect on the quality of the water generated by the conversion of the hydrogen in the fuel cell.

Alternatively, the hydrogen tank may also be a pressurized container that is suitable for storing hydrogen gas under elevated pressure, and may, for instance, exhibit an inner container made of aluminium and jacketed by carbon fibres, as well as an outer jacket made of plastic.

As a further alternative, the fuel-cell system of the supply unit in the aeroplane steam-bath facility according to the invention may also include a device connected to the anode region of the fuel cell for the purpose of generating hydrogen from a hydrogenous medium. For instance, a reforming plant for generating hydrogen from hydrocarbons such as methanol, for example, may be provided.

The fuel-cell system of the supply unit preferably further includes a device that is connected to a cathode region of the fuel cell and that serves for supplying an oxygenous medium to the cathode region of the fuel cell. This device may include, for instance, an oxygen feed pipe connected to the cathode region of the fuel cell and also a compressor or pump arranged in the oxygen feed pipe. The oxygenous medium supplied to the cathode region of the fuel cell is preferably air, which, for instance, can be aspirated out of the cabin of the aeroplane by means of the compressor or pump. Alternatively, however, air may also be supplied to the cathode region of the fuel cell directly from the air-conditioning system of the aeroplane. Finally, it is also conceivable to supply pure oxygen, which is contained in an appropriate storage device, to the cathode region of the fuel cell.

In a preferred embodiment of the aeroplane steam-bath facility according to the invention the supply unit further includes a condensation apparatus for the purpose of condensing hydrogen issuing from the fuel cell. Even in the case where a conventional polymer-electrolyte-membrane fuel cell is employed, the operating temperature of this cell amounts to up to 80° C., so that the water that is generated in the course of the fuel-cell reaction is present in the form of intensely humidified air (relative air humidity 100%). in the case where a high-temperature polymer-electrolyte-membrane fuel cell is employed, which can be operated at temperatures of up to 300° C., the water issuing from the fuel cell is present in the form of water vapour. The condensation apparatus connected downstream of the fuel cell converts the gaseous water vapour into the liquid state and at the same time ensures a cooling of the liquid water to the desired temperature. in the aeroplane steam-bath facility according to the invention the water generated by the condensation apparatus can be used, in particular, in a sauna for sauna infusions or for the operation of a shower or several showers.

The condensation apparatus preferably includes a condensation region and also a collecting region for receiving the liquid water generated in the condensation apparatus, it being possible for the collecting region to have an appropriately large volume, in order to be able to store a certain quantity of liquid water temporarily when required.

The condensation apparatus is preferably connected to a water storage container pertaining to the steam-bath unit, so that the water storage container can be filled, when required, with the water generated by the condensation apparatus or with the water stored temporarily in the collecting region of the condensation apparatus. If the steam-bath unit does not have a storage container, the condensation apparatus may also be directly connected to an appropriate device or to several appropriate devices.

The condensation apparatus and the steam-preparation unit of the supply unit may each be connected to an outlet of the fuel cell. Alternatively, however, it is also possible to connect the steam-preparation unit downstream of the condensation apparatus, or vice versa.

As already mentioned, in principle it is possible to generate water or water vapour of drinking-water quality by means of a fuel-cell reaction, provided that the educts supplied to the fuel cell are sufficiently pure and the components of the fuel-cell system, of the steam-preparation unit and of the condensation apparatus are sufficiently clean, sterile and suitable for food-contact applications. In order to ensure that the water or water vapour supplied to the steam-bath unit of the aeroplane steam-bath facility according to the invention is of sufficiently high quality, a device for measuring the quality of the water or water vapour generated by the fuel cell may be provided in the supply unit. This device—which, for instance, may be connected downstream of the steam-preparation unit and/or of the condensation apparatus or may be integrated into the steam-preparation unit and/or into the condensation apparatus—is preferably also capable of testing the water or water vapour generated by the fuel cell with respect to various selected constituents.

If necessary, the supply unit of the aeroplane steam-bath facility according to the invention may further include a water(-vapour) purification device which, for instance, ensures, through the addition or separation of certain components to or from the water or water vapour generated by the fuel cell, that the water or water vapour supplied to the wellness unit has an appropriate quality, preferably drinking-water quality. The water(-vapour) purification device may, for instance, be integrated into the steam-preparation unit or may be formed separately therefrom.

The supply unit of the aeroplane steam-bath facility according to the invention preferably further includes a heat-management arrangement which serves to control the operating temperature of the fuel cell, of the steam-preparation unit and/or of the condensation apparatus and consequently also the temperature of the water vapour generated by the steam-preparation unit and/or of the water generated by the condensation apparatus. For instance, the heat-management arrangement may include a cooling system for cooling the fuel cell during operation, it being possible for the waste heat of the fuel cell to be recovered, for example via the provision of heat-exchangers in the cooling system, and to be utilised for the purpose of heating the steam-preparation unit. Alternatively, or in addition, thermal energy generated by the fuel cell may also be supplied to the steam-bath unit and utilised there for the purpose of heating a storage container and/or an amenity such as, for example, a sauna or a steam bath. Finally, water for a hot-water shower pertaining to the steam-bath unit may also be heated up to the desired temperature or maintained at the desired temperature by the heat emitted by the fuel cell of the supply unit during operation.

In like manner, waste heat arising in the condensation apparatus in the course of the condensation of the water vapour generated by the fuel cell can be dissipated from the condensation apparatus via an appropriate system, forming a part of the heat-management arrangement, and can be utilised for heating the steam-preparation unit or can be supplied to the steam-bath unit. Excess heat generated during operation of the fuel cell, which cannot be conveyed by the heat-management arrangement for further utilisation, can be dissipated to the environment via an external radiator.

A preferred exemplary embodiment of the invention will now be elucidated on the basis of the appended single FIGURE, which shows a schematic representation of an aeroplane steam-bath facility according to the invention.

In the FIGURE an aeroplane steam-bath facility 10 includes a steam-bath unit 12 and a supply unit 14, the aeroplane steam-hath facility 10 being provided for use on board an aeroplane. The steam-bath unit 12 is provided with fluid-pipe connections and with electrical connections which are connected to corresponding connections provided on the supply unit 14.

The supply unit 14 includes a fuel-cell system 16 with a high-temperature polymer-electrolyte-membrane fuel cell 18. Although only a single fuel cell 18 is shown in the FIGURE, the fuel-cell system 16 has a plurality of high-temperature polymer-electrolyte-membrane fuel cells 18 which are stacked on top of one another for the purpose of forming a fuel-cell stack.

The fuel cell 18 includes an anode region 20 which is separated from a cathode region 24 by an electrolyte 22 designed in the form of a proton-conducting polymer film which is stable up to a temperature of about 300° C. The anode region 20 of the fuel cell 18 is connected to a liquid-hydrogen tank 26 which is filled with high-purity liquid hydrogen. Air is supplied to the cathode region 24 of the fuel cell 18 by means of a compressor 28, said air being withdrawn, in the case where the aeroplane steam-bath facility 10 is being employed on board a passenger aeroplane, from the passenger cabin or from the air-conditioning system of the aeroplane.

During operation of the fuel cell 18, accompanied by generation of electrical energy which is conducted away from the fuel cell 18 via lines 30, 32, the educts hydrogen and atmospheric oxygen supplied to the fuel cell 18 are converted into water, the water at the operating temperature of the high-temperature polymer-electrolyte-membrane fuel cell 18—amounting to about 300° C.—being present in the form of water vapour or, as a consequence of condensation processes in the fuel cell 18 or in pipes connected to the fuel cell 18, in the form of a water/water-vapour mixture. The composition, the pressure and the temperature of the water/water-vapour mixture issuing from the fuel cell 18 may vary, depending on the operating temperature of the fuel cell 18.

The supply unit 14 further includes a condensation apparatus 34 connected to an outlet of the fuel cell 18 for the purpose of condensing the water vapour issuing from an outlet of the fuel cell 18 into liquid water. The condensation apparatus 34 has a condensation region and a collecting region, the collecting region serving for temporary storage of the liquid water generated in the condensation apparatus 34.

Furthermore, a steam-preparation unit 36, which is likewise connected to an outlet of the fuel cell 18 for the purpose of processing the water/water-vapour mixture issuing from the fuel cell 18, is provided in the supply unit 14. The steam-preparation unit 36 ensures that the water/water-vapour mixture issuing from the fuel cell 18 is brought to the requisite temperatures and pressures for use in the steam-bath unit 12, said steam-preparation unit 36 being capable of being controlled by means of an electronic control unit, which is not shown in the FIGURE, in order to be able to adapt the steam-processing process to varying requirements during operation of the steam-bath unit 12. The steam-preparation unit 36 and the electronic control unit assigned to the steam-preparation unit 36 are supplied, via line 30, with electrical energy generated by the fuel cell 18 of the supply unit 14.

A heat-management arrangement 38 serves for controlling the operating temperatures of the fuel cell 18, of the condensation apparatus 34 and of the steam-preparation unit 36 and includes appropriate cooling systems and one or more heat-exchangers which enable a further utilisation of the heat emitted from the fuel cell 18 and also from the condensation apparatus 34 during operation. The heat generated by the fuel cell 18 and by the condensation apparatus 34 during operation is emitted to the heat-management arrangement 38 via pipes 39, 40. On the other hand, heat is supplied to the steam-preparation unit 36 and to the steam-bath unit 12, respectively, via pipes 40, 41. Excess waste heat of the fuel cell 18 and/or of the condensation apparatus 34 is emitted to the environment via an external radiator 44.

The steam-bath unit 12 includes a sauna 46 with an electrical heating system which, via line 32, is supplied with electrical energy generated by the fuel cell 18 of the supply unit 14. Water that can be used for sauna infusions is supplied to the sauna from the condensation apparatus 34 via a pipe 48. Furthermore, in the steam-bath unit 12 there is provided a steam bath 50 to which water vapour that has been brought to the desired temperature and to the desired pressure by the steam-preparation unit 36 is supplied via a pipe 52. Finally, the steam-bath unit 12 includes a shower 54. Water is supplied to the shower 54 from the condensation apparatus 34 via a pipe 56. Furthermore, the water to be emitted via the shower 54 can be heated by means of the thermal energy supplied via pipe 41.

1. An aeroplane steam-bath facility (10) with
a steam-bath unit (12) which includes a steam bath (50), and
a supply unit (14) which includes a fuel-cell system (16) with a fuel cell (18) and a steam-preparation Unit (36) connected to the steam bath (50) for processing water and/or water vapour generated by the fuel cell (18), the steam-preparation unit (36) further being electrically connected to the fuel-cell system (16) in order to be supplied with electrical energy generated by the fuel cell (18),

2. Aeroplane steam-bath facility according to claim 1, characterised in that the supply unit (14) is further adapted to supply the steam-bath unit (12) with energy generated by the fuel cell (18).

3. Aeroplane steam-bath facility according to claim 1, characterised in that the steam-bath unit (12) further includes a sauna (46) and/or at least one shower (54).

4. Aeroplane steam-bath facility according to claim 1, characterised in that the fuel cell (18) is a polymer-electrolyte-membrane fuel cell, in particular a high-temperature polymer-electrolyte-membrane fuel cell.

5. Aeroplane steam-bath facility according to claim 1, characterised in that the fuel-cell system (16) includes a hydrogen tank (26) connected to an anode side (20) of the fuel cell (18) or a device connected to the anode side (20) of the fuel cell (18) for the purpose of generating hydrogen from a hydrogenous medium.

6. Aeroplane steam-bath facility according to claim 1, characterised in that the fuel-cell system (16) includes a device (28) connected to a cathode side (24) of the fuel cell (18) for the purpose of supplying an oxygenous medium to the cathode side (24) of the fuel cell (18).

7. Aeroplane steam-bath facility according to claim 1, characterised in that the supply unit (14) includes a condensation apparat-cs (34) for condensing water vapour issuing from the fuel cell (18).

8. Aeroplane steam-bath Facility according to claim 1, characterised in that supply unit (14) includes a heat-management arrangement (38) for controlling the operating temperature of the fuel cell (18), of the condensation apparatus (34) and/or of the steam-preparation unit (36).
